(19) United States
(12) Patent Application Publication
(10) Pub. No.: US 2015/0163625 A1
(43) Pub. Date: Jun. 11, 2015

(54) SCAN CONTROL SYSTEM, METHOD AND PROGRAM

(71) Applicant: NEC Corporation, Minato-ku, Tokyo (JP)

(72) Inventor: Yoshinori Saida, Tokyo (JP)

(21) Appl. No.: 14/395,553

(22) PCT Filed: Aug. 26, 2013
(86) PCT No.: PCT/JP2013/005021

§ 371 Date: Oct. 20, 2014

(30) Foreign Application Priority Data
Sep. 27, 2012 (JP) 2012-213865

(51) Int. Cl. H04W 4/02

(52) U.S. Cl. CPC H04W 4/02

(57) ABSTRACT

There is provided a scan control system which can reduce a time required to detect and connect to a radio base station and reduce power consumption of a mobile terminal. A storage unit 72 stores position information of predetermined radio base stations corresponding to a user of a mobile terminal 71. A position measuring unit 75 measures a position of the mobile terminal 71. A distance calculating unit 73 calculates a distance between a radio base station which is the closest to the position of the mobile terminal 71, and the mobile terminal 71, among the predetermined radio base stations corresponding to the user. A scan determining unit 74 determines an interval at which the mobile terminal 71 scans radio base stations next after scanning the radio base stations, based on the distance. A scan commanding unit 76 commands the scanning unit 77 to perform scan based on the interval.

### TECHNICAL FIELD

The present invention relates to a scan control system and a scan control method which control scan of a radio base station performed by a mobile terminal, and a mobile terminal, a server device, a mobile terminal program, and a server device program which are applied to the scan control system.

### BACKGROUND ART

There are mobile terminals which are connected to a communication network such as the Internet through radio base stations and which perform communication with various servers on the communication network. A radio base station is, for example, a wireless LAN access point (referred to as a “wireless LAN AP” below). Further, a mobile terminal (referred to as a “wireless LAN terminal” below) which has a wireless LAN communication function performs communication with a server through a wireless LAN AP in a state connected with the wireless LAN AP. Hereinafter, a wireless LAN AP and a wireless LAN terminal will be described as an example. In addition, a wireless LAN terminal is, for example, a personal computer or a smartphone. A wireless LAN terminal also has a communication function which uses public mobile wireless communication such as 3 G communication in addition to a wireless LAN communication function.

Process of connecting a wireless LAN terminal to a wireless LAN AP is as follows. First, a wireless LAN terminal scans wireless LAN APs to detect a wireless LAN AP. As a result of this scan, a wireless LAN terminal acquires information of wireless LAN APs which are present nearby. Subsequently, the wireless LAN terminal is connected to one of the wireless LAN APs detected by the scan. A connection mode in this case is, for example, a mode that a user of a mobile terminal selects a connection target from a plurality of detected wireless LAN APs and commands the wireless LAN terminal to connect to this connection target, or a mode that a wireless LAN terminal automatically selects one of a plurality of wireless LAN APs and connects to this wireless LAN AP. A selection criterion in case of the latter mode is, for example, a reference of selecting a wireless LAN AP to which the mobile terminal was previously connected. Further, when a wireless LAN terminal is connected to a wireless LAN AP, general authentication is performed. Upon authentication, a wireless LAN terminal transmits a password to the wireless LAN AP. Further, in some cases, a wireless LAN terminal stores an inputted password, and automatically transmits the password upon connection to the wireless LAN AP.

The wireless LAN terminal connected to the wireless LAN AP according to the above process can perform communication with a server on a communication network (such as the Internet) through the wireless LAN AP. Meanwhile, when a wireless LAN AP cannot be detected or when processing of connecting to a wireless LAN AP is not performed upon scan, a wireless LAN terminal is not connected to a wireless LAN AP and cannot perform communication with the server.

For a wireless LAN terminal which is assumed to travel together with a user, a wireless LAN AP in the vicinity also changes following travel of the terminal. Hence, a wireless LAN terminal urges a user to perform an operation of selecting and connecting to a wireless LAN AP by performing scan per fixed time and updating a wireless LAN AP list which can be currently connected, or automatically perform processing of connecting to a wireless LAN AP in many cases when detecting a wireless LAN AP to which the mobile terminal was previously connected and which has already stored a password.

PTL 1 discloses a method of controlling a wireless communication module which sets a time until the next scan is performed, according to whether or not communication to an access point can be performed.

PTL 2 discloses a way for gradually increasing a scan interval. Further, PTL 2 discloses a way for transmitting position registration information from a mobile terminal device to update position registration information of the mobile terminal device managed in a public mobile network, and further discloses a way for resetting a wireless LAN scan interval to a default value at a timing at which the mobile terminal device transmits position registration information.

Furthermore, PTL 3 discloses a wireless terminal device which receives distances between other wireless terminal devices and access points, and determines a time which the mobile terminal device starts the next scan, based on the distance.

Still further, PTL 4 discloses a system in which a server manages policy information which indicates whether or not to connect a wireless LAN terminal to an access point, according to a setting of a system administrator.

Moreover, PTL 5 discloses a wireless communication terminal which starts scanning when an RSSI goes below a threshold and stops scanning when the RSSI exceeds the threshold.

Further, NPL 1 discloses an ANDSF policy which complies with an ANDSF (Access Network Discovery and Selection Function) specification which is standardized according to 3GPP (3rd Generation Partnership Project) (see, in particular, Chapter IV, FIGS. 4.2.1 and 4.2.3 in NPL 1).

### CITATION LIST

### Patent Literature

PTL 1: JP 2003-108271 A (paragraph [0012])
PTL 2: JP 2010-187147 A (paragraphs [0007] to [0009])
PTL 3: JP 2010-136033 A (FIG. 1)
PTL 4: JP 2010-263310 A (paragraph [0018])
PTL 5: JP 2011-139357 A (paragraphs [0062] and [0063])

### Non-Patent Literature

NPL 1: “3GPP TS 24.312 V 10.6.0 (2012-06) Technical Specification”, Jun. 27, 2012, [online],[searched on Sep. 11, 2012], Internet <http://www.3gpp.org/ftp/Specs/html-info/24312.htm>, pages 10 to 18

### SUMMARY OF INVENTION

### Technical Problem

A wireless LAN terminal consumes power upon scan. Therefore, when a scan execution interval of a wireless LAN terminal is short, power consumption of a wireless LAN terminal increases.

It is preferable to reduction in a time required to detect and connect to a predetermined wireless LAN AP which is assumed to travel together with a user and reduce power consumption. Meanwhile, a predetermined wireless LAN AP is, for example, a wireless LAN AP to which the user of the wireless LAN terminal previously connected or a wireless LAN AP to which the user has not yet connected and which the user has a right to use. A specific example of the former is a wireless LAN AP which is installed at a home or a working place of the user, and a specific example of the latter is a public wireless LAN AP with which the user contracted.

A technique disclosed in PTL 2 suppresses an increase of power consumption following execution of scan when a scan interval is gradually increased. Further, the technique disclosed in PTL 2 prevents detection of a wireless LAN AP from being delayed due to a long scan interval by resetting to a default value of a wireless LAN scan interval at a timing when a mobile terminal device transmits position registration information.

However, the technique disclosed in PTL 2 resets to a default value of a scan interval irrespectively of whether or not there are predetermined wireless LAN APs nearby, at a timing when the mobile terminal device transmits position registration information. Therefore, in some cases, it is not possible to sufficiently reduce power consumption.

Further, position information of the mobile terminal device which is managed in public mobile communication networks is calculated based on which one of the base stations of the public mobile communication networks the mobile terminal device belongs. A general coverage area of a base station which performs 3 G communication is about several hundred meters to two kilometers, and precision of position information of a mobile terminal device which belongs to a base station which performs 3 G communication is about this level. Further, a coverage area of a wireless LAN AP is several ten meters. Hence, when a mobile terminal device moves to such a degree that a timing to transmit position registration information is not generated while the mobile terminal device belongs to a base station in a public mobile communication network (for example, when the mobile terminal device travels for about several hundred meters), the mobile terminal device crosses coverage areas of a plurality of wireless LAN APs. In this case, a scan interval is not initialized, and the increased scan interval is left as is. Therefore, it is not possible to sufficiently reduce a time required to detect and connect to a wireless LAN AP.

An object of the present invention is to provide a scan control system and a scan control method which detect and connect to a radio base station at a higher speed and reduce power consumption of a mobile terminal, and a mobile terminal, a server device, a mobile terminal program, and a server device program which are applied to the scan control system.

### Solution to Problem

A scan control system according to the present invention includes: a mobile terminal which can connect to a radio base station and which has a position measuring means which measures a position of the mobile terminal; a storage means which stores position information of radio base stations; a distance calculating means which calculates a distance between a radio base station which is the closest to the position of the mobile terminal and the mobile terminal; and a scan interval determining means which determines an interval which the mobile terminal takes to scan the radio base stations next after scanning the radio base stations, based on the distance, and the mobile terminal includes: a scanning means which scans the radio base stations; and a scan commanding means which commands the scanning means to perform scan based on the interval.

Further, a scan control method according to the present invention includes: with a storage means, storing position information of predetermined radio base stations corresponding to a user of a mobile terminal which can connect to a radio base station; with the mobile terminal, measuring a position of the mobile terminal; at a distance calculating means, calculating a distance between a radio base station which is the closest to the position of the mobile terminal and the mobile terminal, among the predetermined radio base stations corresponding to the user; with a scan interval determining means, determining an interval which the mobile terminal takes to scan the radio base stations next after scanning the radio base stations, based on the distance; and with the mobile terminal, scanning the radio base stations based on the interval.

Furthermore, a mobile terminal according to the present invention which can connect to a radio base station includes: a storage means which stores position information of predetermined radio base stations corresponding to a user of the mobile terminal; a position measuring means which measures a position of the mobile terminal; a distance calculating means which calculates a distance between a radio base station which is the closest to the position of the mobile terminal, and the mobile terminal among the predetermined radio base stations corresponding to the user; a scan interval determining means which determines an interval which the mobile terminal takes to scan the radio base stations next after scanning the radio base stations, based on the distance; a scanning means which scans the radio base stations; and a scan commanding means which commands the scanning means to perform scan based on the interval.

Still further, a server device according to the present invention is a server device which performs communication with a mobile terminal which can connect to a radio base station by way of public mobile wireless communication, and which includes: a storage means which stores position information of predetermined radio base stations corresponding to a user of the mobile terminal; a distance calculating means which calculates a distance between a radio base station which is the closest to the position of the mobile terminal and the mobile terminal, among the predetermined radio base stations corresponding to the user; and a scan interval determining means which determines an interval which the mobile terminal takes to scan the radio base stations next after scanning the radio base stations, based on the distance.

Moreover, a mobile terminal program according to the present invention is a mobile terminal program which is implemented on a mobile computer which can connect to a radio base station and which has a storage means which stores position information of predetermined radio base stations corresponding to a user of the computer, and which causes computer to execute: position measurement processing of measuring a position of the computer; distance calculation processing of calculating a distance between a radio base station which is the closest to the position of the computer, and the computer among the predetermined radio base stations corresponding to the user; scan interval determination processing of determining an interval which the computer takes to scan the radio base stations next after scanning the radio base stations, based on the distance; and scan processing of scanning the radio base stations based on the interval.

Further, a server device program according to the present invention is a server device program which is implemented in a computer which performs communication with a mobile terminal which can connect to a radio base station by way of public mobile wireless communication, and which has a storage means which stores position information of predetermined radio base stations corresponding to a user of the mobile terminal, and which causes the computer to execute: distance calculation processing of calculating a distance between a radio base station which is the closest to the position of the mobile terminal and the mobile terminal, among the predetermined radio base stations corresponding to the user; and scan interval determination processing of determining an interval which the mobile terminal takes to scan the radio base stations next after scanning the radio base stations, based on the distance.

### Advantageous Effects of Invention

The present invention can reduce a time required to detect and connect to a radio base station and reduce power consumption of a mobile terminal.

### BRIEF DESCRIPTION OF DRAWINGS

FIG. 1 It depicts a block diagram illustrating a configuration example of a scan control system according to a first exemplary embodiment of the present invention.

FIG. 2 It depicts an explanatory view illustrating an example of information held in a user information database.

FIG. 3 It depicts a flowchart illustrating an example of processing process according to the first exemplary embodiment.

FIG. 4 It depicts a flowchart illustrating an example of processing process according to the first exemplary embodiment.

FIG. 5 It depicts an explanatory view illustrating an example of a policy.

FIG. 6 It depicts an explanatory view illustrating an example where a policy is described as one of Management object (MO) nodes of an ANDSF.

FIG. 7 It depicts an explanatory view illustrating an example of an ANDSF policy in which a MO node is inserted.

FIG. 8 It depicts an explanatory view illustrating an example of an ANDSF policy in which a MO node is inserted.

FIG. 9 It depicts a block diagram illustrating a configuration example of a scan control system according to a second exemplary embodiment of the present invention.

FIG. 10 It depicts a flowchart illustrating an example of processing process according to the second exemplary embodiment.

FIG. 11 It depicts a flowchart illustrating an example of processing process according to the second exemplary embodiment.

FIG. 12 It depicts a block diagram illustrating a configuration example of a scan control system according to a third exemplary embodiment of the present invention.

FIG. 13 It depicts a block diagram illustrating main components of the present invention.

### DESCRIPTION OF EMBODIMENTS

Hereinafter, exemplary embodiments of the present invention will be described with reference to the drawings. Although a wireless LAN AP (wireless LAN access point) and a wireless LAN terminal will be described as examples below, the present invention is also applicable to scan radio base stations other than wireless LAN APs.

### First Exemplary Embodiment

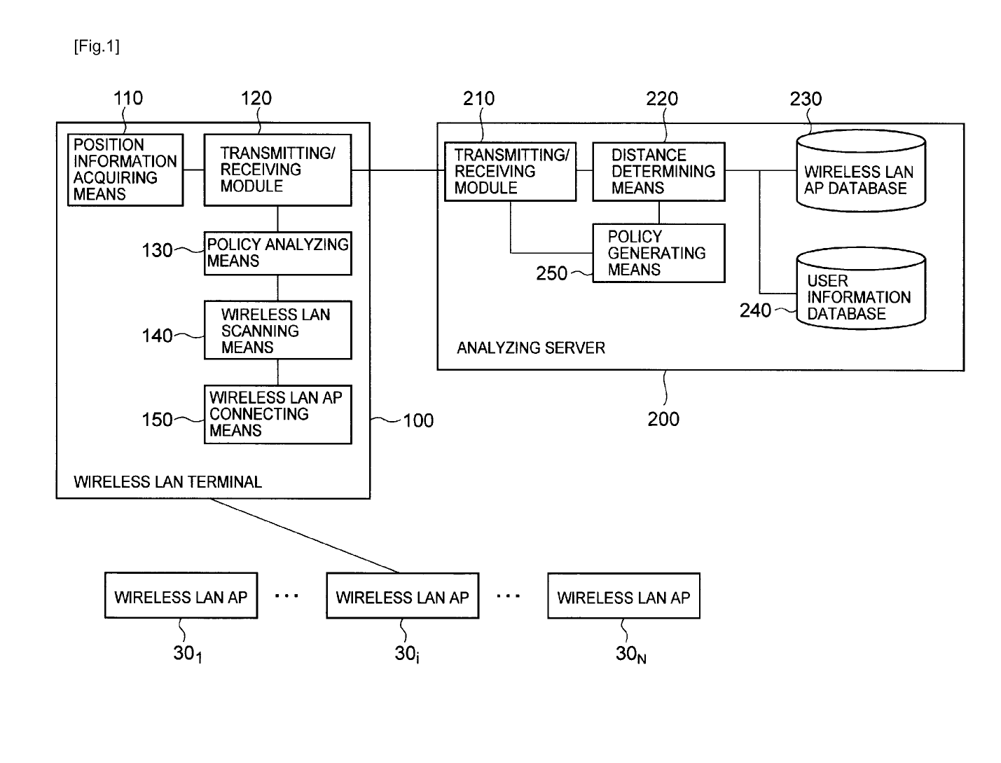

FIG. 1 is a block diagram illustrating a configuration example of a scan control system according to a first exemplary embodiment of the present invention. The scan control system according to the first exemplary embodiment includes a wireless LAN terminal 100 and an analyzing server 200.

The wireless LAN terminal 100 has a wireless LAN communication function, and performs communication with, for example, a server (not illustrated) on the Internet through one of wireless LAN APs. Further, the wireless LAN terminal 100 has a function of performing communication by way of public mobile wireless communication (for example, 3 G communication or LTE (Long Term Evolution)) in addition to wireless LAN communication. Furthermore, the wireless LAN terminal 100 and the analyzing server 200 perform communication by way of public mobile wireless communication.

Wireless LAN APs 30₁ to 30_{N} are arranged various places such as an inside of rooms or an outside of houses. Different parties may install the wireless LAN APs 30₁ to 30_{N}. The wireless LAN APs 30₁ to 30_{N} may include, for example, wireless LAN APs installed at homes by users, wireless LAN APs installed for workers by companies and wireless LAN APs which are provided for profit or for free for general users as public wireless LAN spots.

The wireless LAN terminal 100 includes a position information acquiring means 110, a transmitting/receiving module 120, a policy analyzing means 130, a wireless LAN scanning means 140 and a wireless LAN AP connecting means 150.

The transmitting/receiving means 120 performs public mobile wireless communication with the analyzing server 200.

The position information acquiring means 110 acquires position information which indicates a current position of the wireless LAN terminal 100, and transmits a user ID of the user of the wireless LAN terminal 100 and the position information to the analyzing server 200 through the transmitting/receiving module 120.

The policy analyzing means 130 analyzes a policy generated by a policy generating means 250 of the analyzing server 200, and commands the wireless LAN scanning means 140 to scan wireless LAN APs according to a scan interval described in a policy. Meanwhile, the policy is information which defines an interval at which the wireless LAN terminal 100 scans wireless LAN APs. However, information other than a scan interval may also be described in a policy.

Hereinafter, wireless LAN AP scan is also referred to simply as “wireless LAN scan”.

The wireless LAN scanning means 140 executes wireless LAN scan at the scan interval commanded by the policy analyzing means 130, and detects a wireless LAN AP near the wireless LAN terminal 100.

The wireless LAN AP connecting means 150 performs wireless LAN communication with the wireless LAN AP detected by the wireless LAN scanning means 140, and connects the wireless LAN terminal 100 to the wireless LAN AP.

The position information acquiring means 110, the policy analyzing means 130, the wireless LAN scanning means 140 and the wireless LAN AP connecting means 150 are realized by a CPU of a computer which operates according to, for example, a mobile terminal program. In this case, the CPU only needs to read the mobile terminal program, and operate as each means according to this program. The mobile terminal program may be stored in a computer-readable storage medium. Further, the position information acquiring means 110, the policy analyzing means 130, the wireless LAN scanning means 140 and the wireless LAN AP connecting means 150 may be realized by different hardware, respectively.

The analyzing server 200 has a transmitting/receiving module 210, a distance determining means 220, a wireless LAN AP database 230, a user information database 240 and a policy generating means 250.

The transmitting/receiving module 210 performs public mobile wireless communication with the mobile terminal 100.

When receiving the position information and the user ID of the wireless LAN terminal 100 from the mobile LAN terminal 100, the distance determining means 220 reads position information of predetermined wireless LAN APs corresponding to the user specified by this user ID, from the user information database 240, and calculates a distance between the predetermined wireless LAN AP and the current position of the mobile LAN terminal 100.

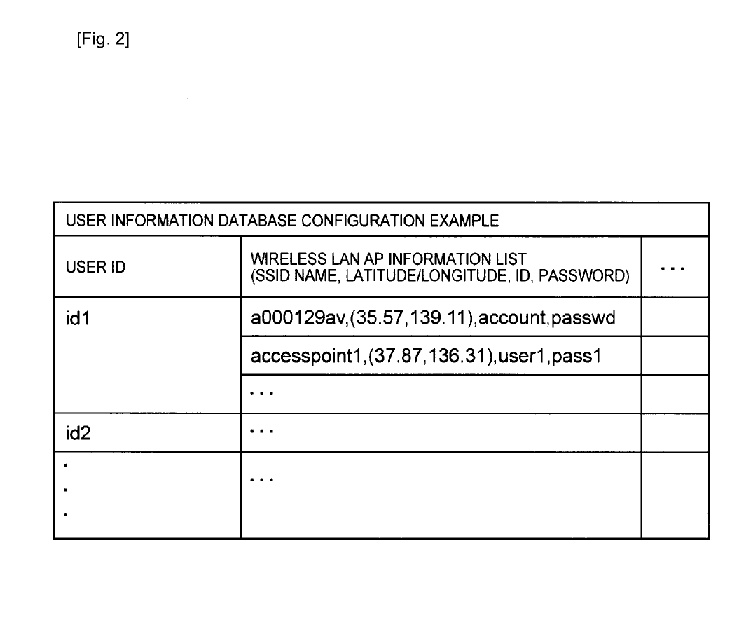

The user information database 240 holds SSIDs (Service Set Identifier) of predetermined wireless LAN APs corresponding to the user, position information of installation sites of the predetermined wireless LAN APs and authentication information (an ID and a password) which is necessary to connect to these predetermined wireless LAN APs. In addition, the SSID is identification information of a wireless LAN AP. FIG. 2 illustrates an example of information held by the user information database 240. In the example illustrated in FIG. 2, position information of an installation site of a wireless LAN AP is represented by a latitude and a longitude. Further, as illustrated in FIG. 2, information of a plurality of predetermined wireless LAN APs may be associated with one user ID.

Meanwhile, as described above, a predetermined wireless LAN AP is, for example, a wireless LAN AP to which the user of the wireless LAN terminal previously connected or a wireless LAN AP to which the user has not yet connected and the user has a right to use.

The user information database 240 holds the above information in advance. For example, each user may register information (see FIG. 2) of a predetermined wireless LAN AP associated with each user, in the user information database 240 in advance.

Alternatively, a business operator of a public wireless LAN AP may register information of predetermined wireless LAN APs corresponding to each user in the user information database 240, based on user management information (for example, a user TD and authentication information) and installation position information of wireless LAN APs.

Further, the wireless LAN terminal 100 may transmit information of a wireless LAN AP connected to this wireless LAN terminal 100, to the analyzing server 200, and register the information in the user information database 240.

The wireless LAN AP database 230 associates and stores the SSID and position information (for example, the latitude and the longitude) of a wireless LAN AP per wireless LAN AP. The wireless LAN AP database 230 may be used to construct the user information database 240.

The policy generating means 250 calculates a wireless LAN scan interval which enables both reduction in time required to detect and connect to a wireless LAN AP and power saving, based on the current position of the wireless LAN terminal 100 and the predetermined wireless LAN AP corresponding to this user, and creates a policy in which this interval is described. A specific example of calculating this wireless LAN scan interval will be described below. The policy generating means 250 transmits the created policy to the wireless LAN terminal 100 through the transmitting/receiving module 210.

The distance determining means 220 and the policy generating means 250 are realized by the CPU of the computer which operates according to, for example, a server device program. In this case, the CPU only needs to read the server device program, and operate as the distance determining means 220 and the policy generating means 250 according to this program. The server device program may be stored in a computer-readable storage medium. Further, the distance determining means 220 and the policy generating means 250 may be realized by different hardware, respectively.

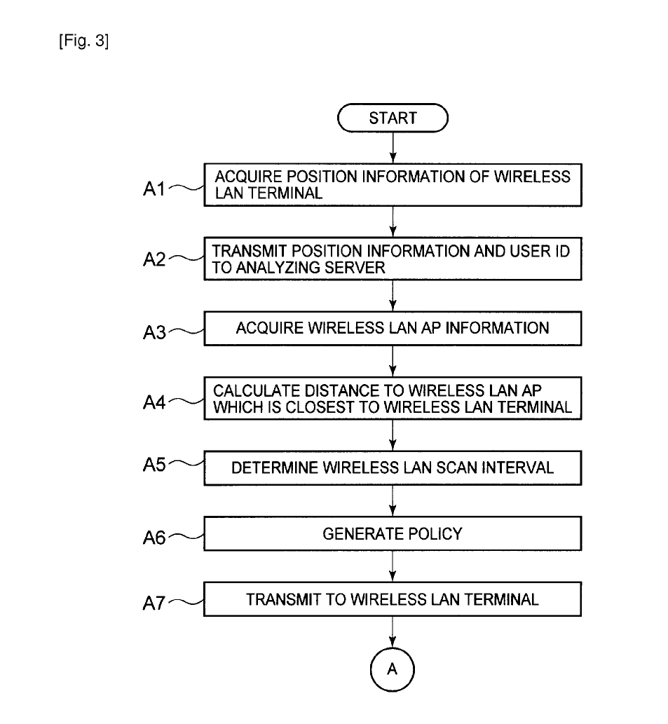

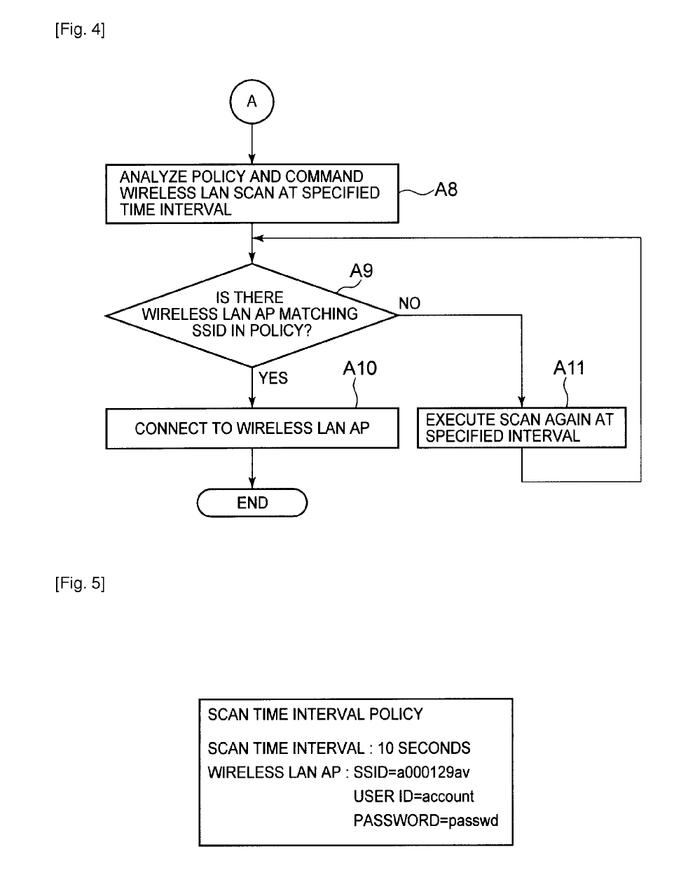

Next, operations will be described. FIGS. 3 and 4 are flowcharts illustrating examples of processing process according to the first exemplary embodiment.

First, the position information acquiring means 110 (see FIG. 1) of the wireless LAN terminal 100 acquires information of the current position of the wireless LAN terminal 100 (step A1). The wireless LAN terminal 100 may execute step A1 on a regular basis, and execute processing subsequent to step A2 after step A1. Alternatively, when determining that the wireless LAN terminal 100 travels for a fixed distance, step A1 may be executed, and processing subsequent to step A2 may be executed after step A1. Whether or not the wireless LAN terminal travels for the fixed distance may be determined using, for example, an acceleration sensor.

In step A1, the position information acquiring means 110 may measure the current position of the wireless LAN terminal 100 by means of, for example, GPS (Global Positioning System). This method is referred to as a “GPS positioning method”. Further, the position information acquiring means 110 may measure the current position of the wireless LAN terminal 100 depending on which one of coverage areas of 3G base stations (not illustrated) the wireless LAN terminal 100 belongs. This method is referred to as a “3G base station positioning method”. Further, the position information acquiring means 110 may measure the current position of the wireless LAN terminal 100 from a database which stores position information of wireless LAN APs based on an SSID of a nearby wireless LAN AP obtained by scan executed by the wireless LAN terminal 100 in the past. This method is referred to as a “wireless LAN positioning method”.

Although the position information is represented by the latitude and the longitude, the position information may be represented in another format. For example, position information may be represented by a name of a city, a ward, a town or a village and a street address.

After step A1, the position information acquiring means 110 transmits the information of the current position and the user ID of the wireless LAN terminal 100 to the analyzing server 200 through the transmitting/receiving module 120 (step A2). The user ID of the user of the wireless LAN terminal 100 transmitted in step A2 is, for example, an international mobile subscriber identity (IMSI), an international mobile equipment identifier (IMEI) or a mobile telephone number. Alternatively, an ID number uniquely allocated to the wireless LAN terminal 100 or the user may be used as a user ID.

When receiving the information of the current position and the user ID of the wireless LAN terminal 100 through the transmitting/receiving module 210, the distance determining means 220 of the analyzing server 200 reads information (see FIG. 3 as to SSIDs, position information and authentication information) of predetermined wireless LAN APs corresponding to this user ID from the user information database (step A3). When a plurality of predetermined wireless LAN APs corresponding to the user ID is registered, the distance determining means 220 reads information of each wireless LAN AP.

Further, the distance determining means 220 calculates a distance between a wireless LAN AP which is the closest to the current position of the wireless LAN terminal 100 and the current position of the wireless LAN terminal 100 among predetermined wireless LAN APs corresponding to the user ID (step A4). For example, the distance determining means 220 only needs to calculate the distance to the current position of the wireless LAN terminal 100 per predetermined wireless LAN AP corresponding to the user ID and to specify the shortest distance.

The policy generating means 250 calculates a wireless LAN scan interval which enables reduction in time required to detect and connect a wireless LAN AP, and power saving, based on the distance calculated in step A4 (step A5).

A specific example of calculating a wireless LAN scan interval in step A5 will be described. The policy generating means 250 may determine the wireless LAN scan interval such that, for example, in proportion to the distance calculated in step A4 (the distance between a predetermined wireless LAN AP which is the closest to the current position of the wireless LAN terminal 100 and the current position of the wireless LAN terminal 100), the wireless LAN scan interval increases, and determine not to execute wireless LAN scan when this distance exceeds a threshold. The wireless LAN scan interval is determined in this way, so that, when there are predetermined wireless LAN APs near the wireless LAN terminal 100, wireless LAN scan is executed at a short interval and, consequently, it is possible to detect this wireless LAN AP at a high speed and finish connection processing. Meanwhile, when the distance between the wireless LAN terminal 100 and the predetermined wireless LAN AP is very long and a significant time is required by the user to reach there, it is possible to suppress an increase in power consumption resulting from wireless LAN scan by increasing a wireless LAN scan interval or by not executing wireless LAN scan.

Further, the policy generating means 250 may calculate a wireless LAN scan interval by also using a moving speed of the wireless LAN terminal 100. In this case, the policy generating means 250 determines the wireless LAN scan interval such that the wireless LAN scan interval increases in proportion to the distance calculated in step A4 and the wireless LAN scan interval decreases when the traveling speed is faster. That is, the policy generating means 250 may calculate a wireless LAN scan interval by calculating following equation (1).

Wireless LAN scan interval =(a*D)/(b*S) Equation (1)

Where D indicated in equation (1) is the distance calculated in step A4, S is a traveling speed of the wireless LAN terminal 100, and a and b are predetermined proportional constants. In addition, in this case, the wireless LAN terminal 100 only needs to transmit the traveling speed to the analyzing server 200 together with position information and the user ID in step A2.

Further, the policy generating means 250 may determine a combination of a time spent until wireless LAN scan is executed for the first time after the policy analyzing means 130 commands the wireless LAN scanning means 140 to execute wireless LAN scan, and a subsequent wireless LAN scan interval. For example, the wireless LAN terminal 100 is in a coverage area of the wireless LAN AP 30ᵢ. In this case, the policy generating means 250 may determine that the wireless LAN scanning means 140 starts scan 0 msec after the policy analyzing means 130 commands the wireless LAN scanning means 140 to execute wireless LAN scan for the first time, and set a small value as a subsequent wireless LAN scan interval. This “small value” may be set in advance as a constant.

After step A5, the policy generating means 250 generates a policy in which the wireless LAN scan interval determined in step A5 is described (step A6). FIG. 5 is an explanatory view illustrating an example of a policy. As illustrated in FIG. 5, the policy generating means 250 includes in the policy the wireless LAN scan interval and, in addition, an SSID of a wireless LAN AP (i.e. a predetermined wireless LAN AP which is at the closest distance to the wireless LAN terminal 100) for which the distance to the wireless LAN terminal 100 is calculated in step A4 and authentication information (a user ID and a password) used by the user upon connection to this wireless LAN AP.

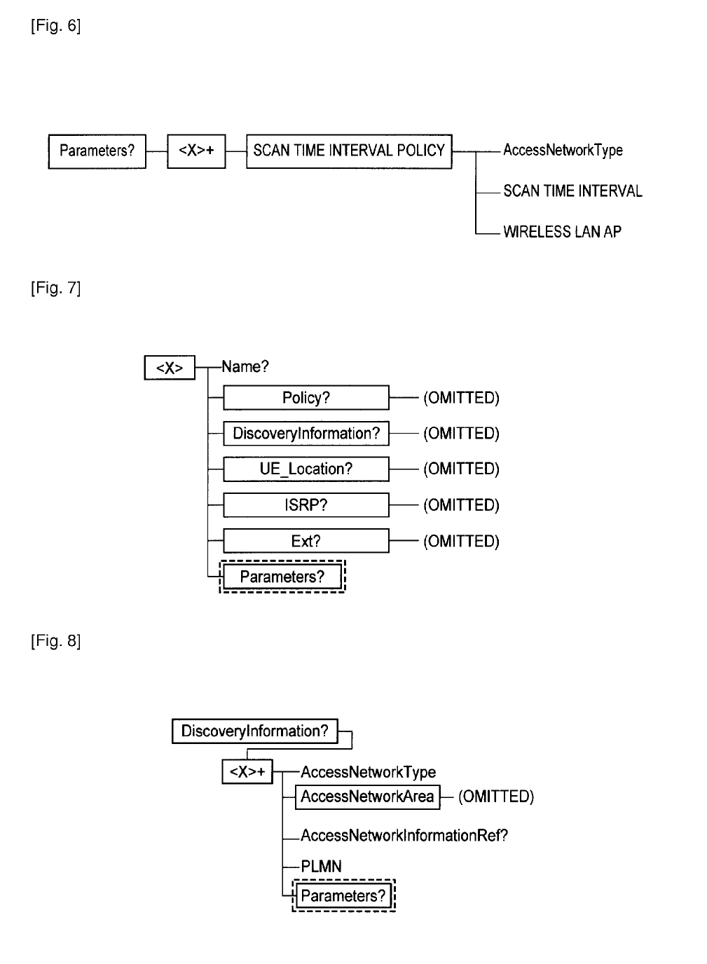

Further, the policy generating means 250 may insert the policy in which the wireless LAN scan interval, the SSID and the authentication information are described, in an ADNSF policy complying with an ANDSF specification disclosed in NPL 1. FIG. 6 illustrates an example where a policy which defines a wireless LAN scan interval as one of management object (MO) nodes of the ANDSF. The policy generating means 250 may insert this node in the ANDSF policy. FIGS. 7 and 8 are explanatory views illustrating examples of an ANDSF policy in which a MO node is inserted. FIG. 7 illustrates that a node in which a wireless LAN scan interval is described is inserted at an uppermost class of a tree, and FIG. 8 illustrates insertion to a subordinate of a management object which is discovery information. In the examples illustrated in FIGS. 7 and 8, the wireless LAN scan interval, the SSID and the authentication information subsequent to “Parameters?” are described.

In addition, in the example illustrated in FIG. 6, “AccessNetworkType” is a parameter which specifies a wireless type in the ANDSF, and “WLAN” is assumed to be specified according to the ANDSF specification. Further, a parameter name illustrated in FIG. 6 is exemplary, and may have another parameter name.

The policy generating means 250 transmits the generated policy to the wireless LAN terminal 100 through the transmitting/receiving module 210 (step A7).

When receiving this policy through the transmitting/receiving module 120, the policy analyzing means 130 of the wireless LAN terminal 100 analyzes this policy, and commands the wireless LAN scanning means 140 to execute wireless LAN scan according to the wireless LAN scan interval described in the policy (step A8).

The wireless LAN scanning means 140 executes wireless LAN scan under control of the policy analyzing means 130, and detects zero, one or a plurality of wireless LAN APs. When the number of detected wireless LAN APs is zero, this means that no wireless LAN AP is detected. The wireless LAN scanning means 140 can acquire information including SSIDs of the detected wireless LAN APs. The wireless LAN AP connecting means 150 determines whether or not there is a wireless LAN AP matching the SSID described in the policy from the detected wireless LAN APs (step A9).

When the wireless LAN AP matching the SSID described in the policy is detected (Yes in step A9), the wireless LAN AP connecting means 150 connects the wireless LAN terminal 100 to this wireless LAN AP using the authentication information described in the policy (step A10), and finishes the processing.

When the wireless LAN AP matching the SSID described in the policy is not detected (No in step A9), the wireless LAN AP connecting means 150 executes wireless LAN scan at the interval specified by the policy analyzing means 130 (step A11). Further, an operation subsequent to step A9 is repeated.

When processing in step A11 and step A9 is repeated, the wireless LAN scanning means 140 may gradually increase a wireless LAN scan interval according to the number of execution times of wireless LAN scan. Further, when the number of repetition times of processing in step A11 and step A9 exceeds a predetermined number of times, processing may return to step A1 by stopping this repetition processing, and processing subsequent to step A1 may be executed. Furthermore, when it is detected that the wireless LAN terminal 100 travels for a fixed distance or more, processing may return to step A1 and processing subsequent to step A1 may be executed.

Still further, an example has been described with the above exemplary embodiment where an SSID and authentication information (a user ID and a password) of one wireless LAN AP are described in a policy (see FIG. 5). The policy generating means 250 may select a plurality of wireless LAN APs in order of wireless LAN APs closer to the wireless LAN terminal 100, and describe a determined SSID and authentication information of each wireless LAN AP in a policy. In this case, a SSID and authentication information of wireless LAN APs closer to the wireless LAN terminal 100 are described. Further, the wireless LAN AP connecting means 150 sequentially selects an SSID in order of SSIDs of the wireless LAN APs closer to the wireless LAN terminal 100 in step A9 (see FIG. 4), determines whether or not a wireless LAN AP matching the selected SSID is detected and, if detected, only needs to execute step A10. Furthermore, when a wireless LAN AP matching each SSID described in the policy is not detected, processing subsequent to step A11 only needs to be repeated.

According to the present exemplary embodiment, a distance between the wireless LAN terminal 100 and a wireless LAN AP which is the closest to the wireless LAN terminal 100 among predetermined wireless LAN APs corresponding to the user is calculated, and an interval of wireless LAN scan executed by the wireless LAN terminal 100 may be set. For example, the policy generating means 250 sets a longer wireless LAN scan interval when this distance is longer. Hence, when there are predetermined wireless LAN APs near the wireless LAN terminal 100, a short wireless LAN scan interval is set. In this case, even when a short wireless LAN scan interval is set, there are wireless LAN APs near the wireless LAN terminal 100, so that detection and connection can be finished at a high speed, and the number of times of repetition of scan is small, so that power consumption does not increase. Further, when there are not predetermined wireless LAN APs near the wireless LAN terminal 100, a long wireless LAN scan interval is set. In this case, the number of repetitions of wireless LAN scan becomes small, so that it is possible to save power.

Thus, the present invention can reduce a time required to detect and connect to a radio base station and reduce power consumption of a wireless LAN terminal.

### Second Exemplary Embodiment

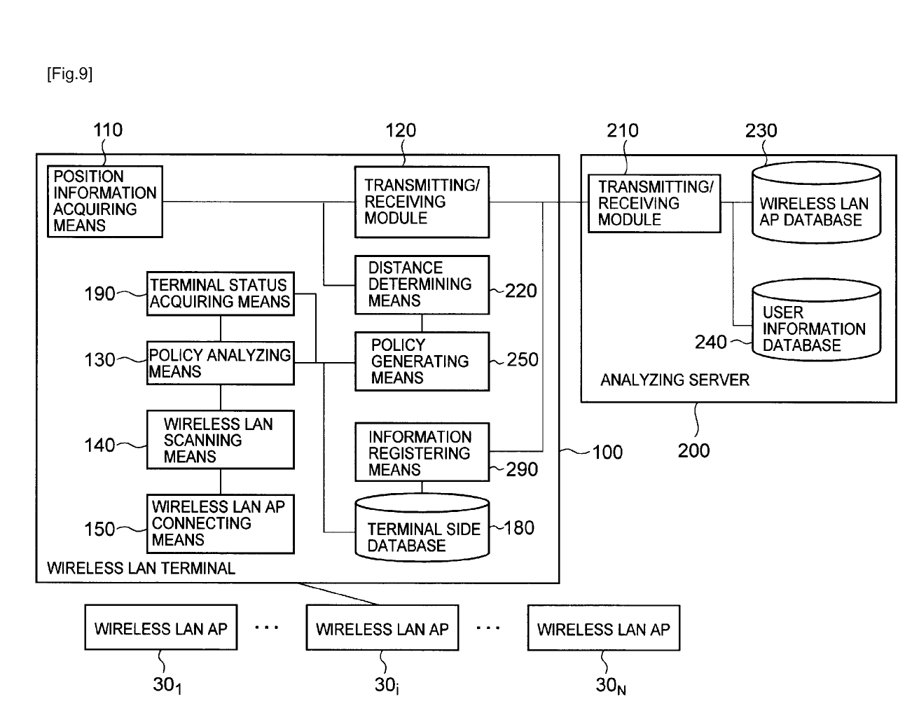

FIG. 9 is a block diagram illustrating a configuration example of a scan control system according to a second exemplary embodiment of the present invention. The same components as those in the first exemplary embodiment will be assigned the same reference numerals as those in FIG. 1, and will not be described in detail.

In the second exemplary embodiment, the wireless LAN terminal 100 includes components of the wireless LAN terminal 100 according to the first exemplary embodiment and, in addition, a distance determining means 220, a policy generating means 250, an information registering means 290, a terminal side database 180 and a terminal status acquiring means 190.

A distance determining means 220 and a policy generating means 250 included in an analyzing server 200 according to the first exemplary embodiment are included in the wireless LAN terminal 100 in the second exemplary embodiment.

The terminal side database 180 holds SSIDs of predetermined wireless LAN APs corresponding to the user of the wireless LAN terminal 100, position information of the predetermined wireless LAN APs and authentication information (an ID and a password) which is necessary to connect to these predetermined wireless LAN APs. That is, the terminal side database holds information associated with the user ID of the wireless LAN terminal 100 among information (see FIG. 2) included in the user information database 240 of the analyzing server 200.

The information registering means 290 transmits the user ID of the user of the wireless LAN terminal 100 to the analyzing server 200 through the transmitting/receiving module 120, and requests an SSID, position information of wireless LAN AP and authentication information stored in the user information database 240 in association with the user ID. An information providing means (not illustrated) of the analyzing server 200 reads the SSID, the position information of the wireless LAN APs and the authentication information associated with the received user ID from the user information database 240 in response to this request, and transmits the SSID, the position information and the authentication information to the wireless LAN terminal 100 of a request source. When receiving these pieces of information, the information registering means 290 registers the information in the terminal side database 180.

In addition, the terminal side database 180 may hold SSIDs, position information and authentication information related to predetermined wireless LAN APs which are present in N km from the current position of the wireless LAN terminal 100 among the predetermined wireless LAN APs corresponding to the user of the wireless LAN terminal 100. In this case, for example, the information registering means 290 transmits the user ID and the information of the current position to the analyzing server 200 following movement of the wireless LAN terminal 100. Further, the information providing means (not illustrated) of the analyzing server 200 specifies predetermined wireless LAN APs which exist in N km from the current position of the wireless LAN terminal 100 among the predetermined wireless LAN APs corresponding to the user ID, reads SSIDs of the wireless LAN APs, position information of the wireless LAN APs and authentication information from the user information database 240, and transmits the SSIDs, the position information and the authentication information to the wireless LAN terminal 100 of the request source. When receiving these pieces of information, the information registering means 290 registers the information in the terminal side database 180.

The terminal status acquiring means 190 acquires information (referred to as “terminal status information” below) which indicates a current status of the wireless LAN terminal 100. A status of the wireless LAN terminal 100 is, for example, a lighting status of a display unit (not illustrated) of the wireless LAN terminal 100, an activation status of application software, whether or not there is application software which is performing activation or communication, the type of communication, the amount of communication and a traveling speed of the wireless LAN terminal 100. The terminal status acquiring means 190 may acquire terminal status information which indicates part of these statuses, and acquire terminal status information which indicates another status related to the wireless LAN terminal 100.

The position information acquiring means 110, the policy analyzing means 130, the wireless LAN scanning means 140, the wireless LAN AP connecting means 150, the distance determining means 220, the policy generating means 250, the information registering means 290 and the terminal status acquiring means 190 are realized by a CPU of a computer which operates according to, for example, a mobile terminal program. Further, these components may be realized by different hardware, respectively.

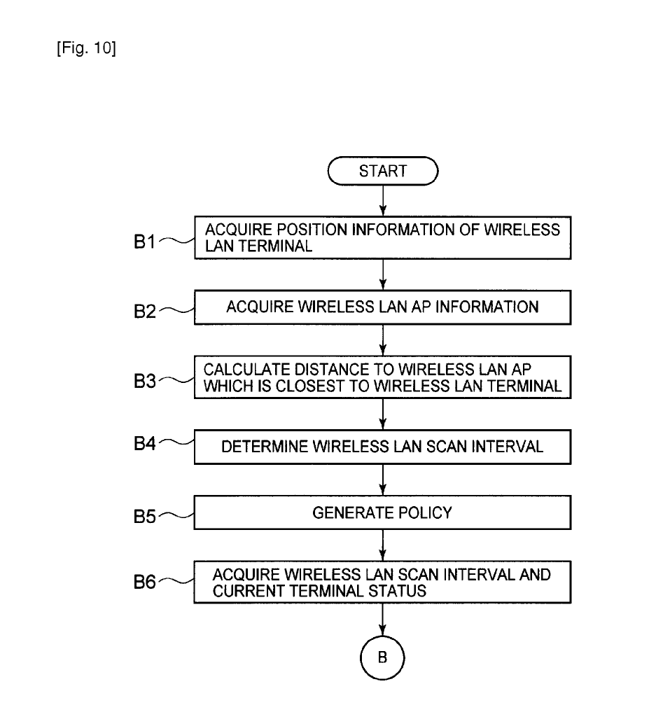

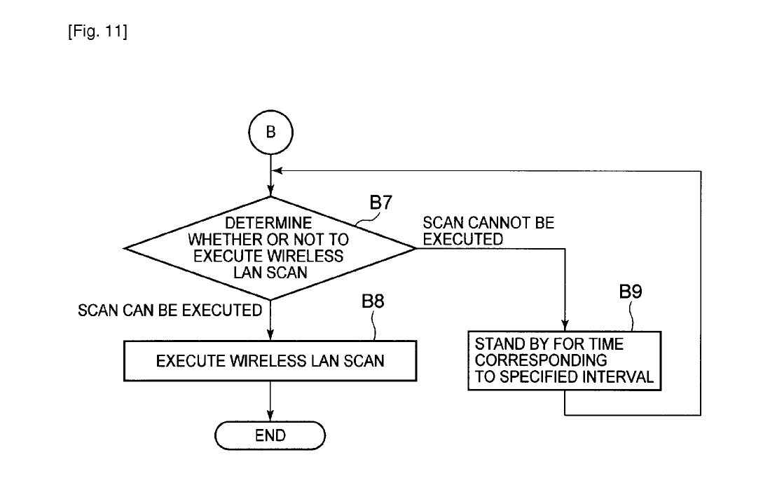

Next, operations will be described. FIGS. 10 and 11 are flowcharts illustrating an example of processing process according to the second exemplary embodiment.

First, the position information acquiring means 110 of the wireless LAN terminal 100 acquires information of the current position of the wireless LAN terminal 100 (step B1). This processing is the same as in step A1 (see FIG. 3).

Next, the distance determining means 220 (see FIG. 9) reads information of predetermined wireless LAN APs (SSIDs, position information and authentication information) held in the terminal side database 180 (step B2). When information of a plurality of wireless LAN APs is registered, the distance determining means 220 reads information of each wireless LAN AP.

Further, the distance determining means 220 calculates a distance between a wireless LAN AP which is closest to the current position of the wireless LAN terminal 100 and the current position of the wireless LAN terminal 100 among predetermined wireless LAN APs corresponding to the user of the wireless LAN terminal 100 (step B3). For example, the distance determining means 220 only needs to calculate the distance to the current position of the wireless LAN terminal 100 per predetermined wireless LAN AP and to specify the shortest distance.

The policy generating means 250 calculates a wireless LAN scan interval based on the distance calculated in step B3 (step B4). This processing is the same as in step A5 (see FIG. 3). To calculate a wireless LAN scan interval by also using the traveling speed of the wireless LAN terminal 100, the traveling speed acquired by the terminal status acquiring means 190 only needs to be used.

Next, the policy generating means 250 generates a policy in which the wireless LAN scan interval determined in step B4 is described (step B5). This processing is the same as in step A6 (see FIG. 3), and the policy generating means 250 includes in the policy the wireless LAN scan interval and, in addition, an SSID of a wireless LAN AP (i.e. a predetermined wireless LAN AP which is at the closest distance to the wireless LAN terminal 100) for which the distance to the wireless LAN terminal 100 is calculated in step B4 and authentication information (a user ID and a password) used by the user upon connection to this wireless LAN AP.

The policy analyzing means 130 analyzes the generated policy, and refers to the wireless LAN scan interval described in the policy. Further, the policy analyzing means 130 acquires information of a current terminal status from the terminal status acquiring means 190 (step B6).

Furthermore, the policy analyzing means 130 determines whether or not to execute wireless LAN scan based on the terminal status information (step B7).

An example of determination in step B7 will be described. When, for example, the terminal status information indicates that the user is not operating the mobile LAN terminal 100, the policy analyzing means 130 determines to execute wireless LAN scan. Meanwhile, when the terminal status information indicates that the user is operating the mobile LAN terminal 100, the policy analyzing means 130 determines not to execute wireless LAN scan.

Further, when an activated application requires communication of a large volume, it is more preferable to perform wireless LAN communication of a larger volume than public mobile communication such as 3G. Hence, the policy analyzing means 130 may determine to execute wireless LAN scan when the activated application requires the communication of a volume equal to or more than a threshold, and determine not to execute wireless LAN scan when the activated application does not require communication of a volume equal to or more than a threshold.

Further, when a traveling speed of the wireless LAN terminal 100 is the threshold or more, the wireless LAN terminal 100 passes in a short time an area in which a wireless LAN AP can perform communication, and cannot use a wireless LAN substantially. Hence, the policy analyzing means 130 may determine to execute wireless LAN scan when the traveling speed of the wireless LAN terminal 100 is less than a threshold, and determine not to execute wireless LAN scan when the traveling speed is the threshold or more.

When it is determined not to execute wireless LAN scan, the policy analyzing means 130 stands by for a time corresponding to the wireless LAN scan interval described in the policy (step B9), and processing subsequent to step B7 is performed again.

When it is determined to execute wireless LAN scan, the policy analyzing means 130 commands the wireless LAN scanning means 140 to execute wireless LAN scan. The wireless LAN scanning means 140 executes wireless LAN scan under control of the policy analyzing means 130 (step B8). When there is a wireless LAN AP matching the SSID described in the policy among the detected wireless LAN APs, the wireless LAN AP connecting means 150 connects the wireless LAN terminal 100 to this wireless LAN AP using the authentication information described in the policy, and finishes the processing. In addition, when a wireless LAN AP is not detected upon wireless LAN scan, if a time corresponding to a wireless scan interval passes, processing subsequent to step B7 is performed again.

In the present exemplary embodiment, it is possible to provide an effect of adjusting a wireless LAN scan interval according to a status of the wireless LAN terminal 100 in addition to an effect according to the first exemplary embodiment.

### Third Exemplary Embodiment

In a third exemplary embodiment, by defining not only a wireless LAN scan interval in a policy but also a position information acquiring method and acquisition interval of a wireless LAN terminal 100, power saving performance is improved. The position information acquisition interval is a time until next position information is acquired after the position information acquiring means 110 acquires position information of the wireless LAN terminal 100.

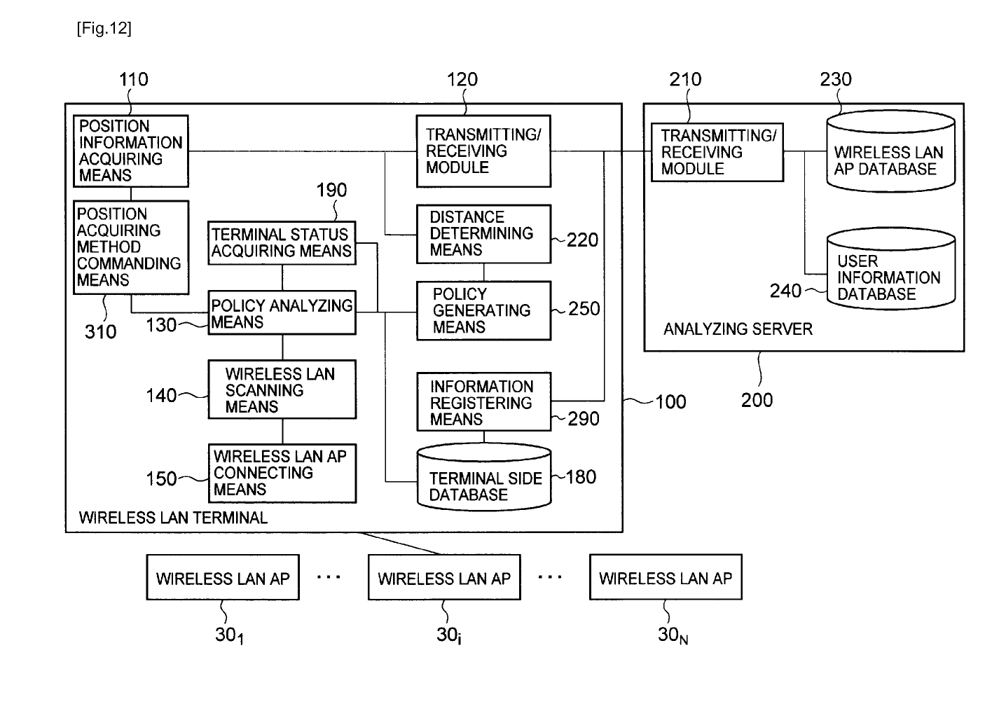

FIG. 12 is a block diagram illustrating a configuration example of a scan control system according to the third exemplary embodiment of the present invention. The same components as those in the second exemplary embodiment will be assigned the same reference numerals as those in FIG. 9, and will not be described in detail.

In the third exemplary embodiment, the wireless LAN terminal 100 includes components of the wireless LAN terminal 100 according to the second exemplary embodiment and, in addition, a position acquiring method commanding means 310.

The position acquiring method commanding means 310 commands a position information acquiring method and an acquisition interval with which the position information acquiring means 110 acquires position information of the wireless LAN terminal 100. The position acquiring method commanding means 310 is realized by a CPU of a computer which operates according to, for example, a mobile terminal program.

In addition, when the position acquiring method commanding means 310 does not determine a position information acquiring method and acquisition interval, the position information acquiring means 110 acquires position information of the wireless LAN terminal 100 according to a predetermined mode.

The position information acquiring method is, for example, a GPS positioning method, a 3G base station positioning method and a wireless LAN positioning method. Upon comparison of these methods, precision of position information is the highest with the GPS positioning method, is the second highest with the wireless LAN positioning method and is the lowest with the 3G base station positioning method. The precision of the GPS positioning method is about 10 meters, the precision of the wireless LAN positioning method is about several ten meters and the precision of the 3G base station positioning method is about several hundred meters to two kilometers. Further, power consumption is the highest with the GPS positioning method, is the second highest with the wireless LAN positioning method and is the lowest with the 3G base station positioning method.

The position acquiring method commanding means 310 determines a position information acquiring method and a position information acquisition interval when the policy generating means 250 determines a wireless LAN scan interval in step B4 (see FIG. 10). The position acquiring method commanding means 310 determines the position information acquiring method and the position information acquisition interval based on a distance obtained in step B3 (a distance from the wireless LAN terminal 100 to the closest wireless LAN AP). Hereinafter, this distance is represented by D. The position acquiring method commanding means 310 sets a long position information acquisition interval in proportion to, for example, the distance D.

When creating the policy in step B5 (see FIG. 10), the policy generating means 250 also describes in the policy the position information acquiring method and the position information acquisition interval commanded by the position acquiring method commanding means 310. The position information acquiring means 110 executes step B1 according to the position information acquiring method and the position information acquisition interval. As described above, when the position information acquiring method and acquisition interval are not determined (when, for example, step B1 is executed for the first time), the position information acquiring means 110 acquires position information of the wireless LAN terminal 100 according to the predetermined mode.

An example will be described where the position acquiring method commanding means 310 determines a position information acquiring method and a position information acquisition interval.

When the distance D is a distance (more specifically, about several ten meters) which is within a coverage area of a wireless LAN AP, the policy generating means 250 sets a wireless LAN scan interval to one second such that wireless LAN scan is executed immediately. Further, the position acquiring method commanding means 310 sets designation related to the position information acquiring method and the position information acquisition interval to “none” such that position information acquisition processing is not performed. As a result, the wireless LAN terminal 100 can finish processing of connecting to a wireless LAN AP at a high speed, and improve power saving performance by not performing position information acquisition processing.

Further, when the distance D is about several hundred meters, the policy generating means 250 determines not to execute wireless LAN scan. Furthermore, the position acquiring method commanding means 310 determines the precise GPS positioning method as a position information acquiring method. Still further, the position acquiring method commanding means 310 determines a position information acquisition interval as a time which is short to some degree (for example, about one minute). As a result, the wireless LAN terminal 100 does not execute unnecessary wireless LAN scan, and repeats acquiring position information at relatively short intervals according to the precise GPS positioning method. As a result, it is possible to determine at a high speed whether or not the wireless LAN terminal enters a coverage area of a wireless LAN AP.

Further, when the distance D is about several kilometers or more, the policy generating means 250 determines not to execute wireless LAN scan. Furthermore, the position acquiring method commanding means 310 determines the less precise 3G positioning method as a position information acquiring method. Still further, the position acquiring method commanding means 310 determines a position information acquisition interval as a time which is long to some degree (for example, about ten minutes). The distance D is several kilometers or more means that there is not a predetermined wireless LAN AP corresponding to the user. Consequently, by making the above setting, it is possible to suppress power consumption accompanying position information acquisition and wireless LAN scan.

In the third exemplary embodiment, the wireless LAN terminal 100 specifies not only a wireless LAN scan interval but also a position information acquiring method and a position information acquisition interval, so that it is possible to execute more efficient position information acquisition and wireless LAN scan, and detect a wireless LAN AP at a high speed and improve power saving performance.

In the second exemplary embodiment (see FIG. 9) and the third exemplary embodiment (see FIG. 12), the distance determining means 220 and the policy generating means 250 may be provided in the analyzing server 200.

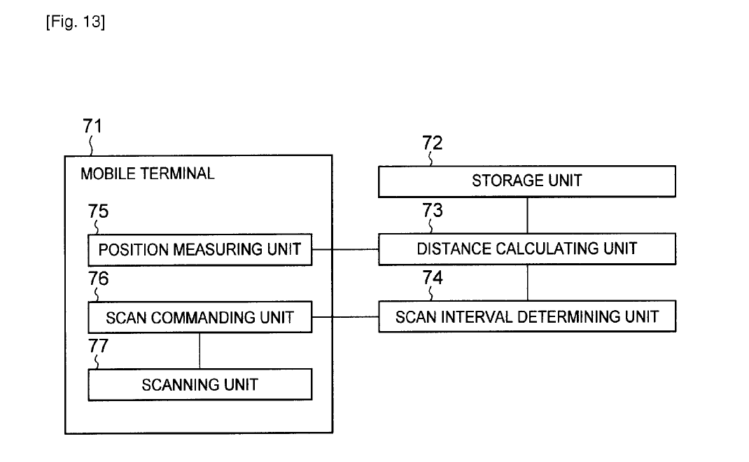

Next, the main components of the present invention will be described. FIG. 13 is a block diagram illustrating the main components of the present invention. A scan control system according to the present invention includes a mobile terminal 71 which can connect to a radio base station, a storage unit 72, a distance calculating unit 73 and a scan interval determining unit 74. Further, the mobile terminal 71 includes a position measuring unit 75, a scan commanding unit 76 and a scanning unit 77.

The storage unit 72 (for example, a user information database 240 and a terminal side database 180) stores position information of radio base stations.

The position measuring unit 75 (for example, a position information acquiring means 110) measures a position of the mobile terminal 71.

The distance calculating unit 73 (for example, a distance determining means 220) calculates a distance between a radio base station which is the closest to the position of the mobile terminal 71, and the mobile terminal 71.

The scan interval determining unit 74 (for example, a policy generating means 250) determines an interval which the mobile terminal 71 takes to perform next scan after scanning radio base stations, based on this distance.

The scanning unit 77 (for example, a wireless LAN scanning means) scans radio base stations.

The scan commanding unit 76 (for example, a policy analyzing means 130) commands the scanning unit 77 to execute scan based on this interval.

According to this configuration, it is possible to reduce a time required to detect and connect to a radio base station and reduce power consumption of a mobile terminal.

A configuration may be employed where the storage unit 72 stores position information of predetermined radio base stations corresponding to a user of the mobile terminal 71, and the distance calculating unit 73 calculates a distance between a radio base station which is the closest to the position of the mobile terminal 71 and the mobile terminal 71 among the predetermined radio base stations corresponding to the user.

The storage unit 72, the distance calculating unit 73 and the scan interval determining unit 74 may be provided in a server device (for example, the analyzing server 200) which performs communication with the mobile terminal 71 by way of public mobile wireless communication.

The storage unit 72, the distance calculating unit 73 and the scan interval determining unit 74 may be provided in the mobile terminal 71.

A configuration may be employed where the mobile terminal 71 has a terminal status information acquiring unit (for example, the terminal status acquiring means 190) which acquires terminal status information which indicates a status of the mobile terminal 71, and the scan commanding unit 76 determines whether or not scan can be executed, based on the terminal status information.

A configuration may be employed where the mobile terminal 71 has a position information measuring method determining unit (for example, a position acquiring method commanding means 310) which determines a method and an interval with which the position measuring unit 75 measures the position of the mobile terminal 71, based on the distance calculated by the distance calculating unit 73, and the position measuring unit 75 measures the position of the mobile terminal according to the method and the interval determined by the position information measuring method determining unit.

Part or all of the embodiments may be described as in the following supplementary notes, but are not limited to the following.

(Supplementary note 1) A scan control system comprising: a mobile terminal which can connect to a radio base station and which comprises a position measuring means which measures a position of the mobile terminal; a storage means which stores position information of radio base stations; a distance calculating means which calculates a distance between a radio base station which is the closest to the position of the mobile terminal and the mobile terminal; and a scan interval determining means which determines an interval which the mobile terminal takes to scan the radio base stations next after scanning the radio base stations, based on the distance, wherein the mobile terminal comprises: a scanning means which scans the radio base stations; and a scan commanding means which commands the scanning means to perform scan based on the interval.

(Supplementary note 2) The scan control system according to Supplementary note 1, wherein: the storage means stores position information of predetermined radio base stations corresponding to a user of the mobile terminal; and the distance calculating means calculates the distance between the radio base station which is the closest to the position of the mobile terminal, and the mobile terminal among the predetermined radio base stations corresponding to the user.

(Supplementary note 3) The scan control system according to Supplementary note 1 or 2, wherein the storage means, the distance calculating means and the scan interval determining means are provided in a server device which performs communication with the mobile terminal by way of public mobile wireless communication.

(Supplementary note 4) The scan control system according to Supplementary note 1 or 2, wherein the storage means, the distance calculating means and the scan interval determining means are provided in the mobile terminal.

(Supplementary note 5) The scan control system according to any one of Supplementary note 1 to Supplementary note 4, wherein the mobile terminal comprises a terminal status information acquiring means which acquires terminal status information which indicates a status of the mobile terminal, and the scan commanding means determines whether or not scan can be executed based on the terminal status information.

(Supplementary note 6) The scan control system according to any one of Supplementary note 1 to Supplementary note 5, wherein the mobile terminal comprises a position information measuring method determining means which determines a method and an interval with which the position measuring means measures the position of the mobile terminal, based on the distance calculated by the distance calculating means; and the position measuring means measures the position of the mobile terminal according to the method and the interval determined by the position measuring method determining means.

(Supplementary note 7) A scan control method comprising: at a storage means, storing position information of predetermined radio base stations corresponding to a user of a mobile terminal which can connect to a radio base station; at the mobile terminal, measuring a position of the mobile terminal; at a distance calculating means, calculating a distance between a radio base station which is the closest to the position of the mobile terminal and the mobile terminal, among the predetermined radio base stations corresponding to the user; at a scan interval determining means, determining an interval which the mobile terminal takes to scan the radio base stations next after scanning the radio base stations, based on the distance; and at the mobile terminal, scanning the radio base stations based on the interval.

(Supplementary note 8) A mobile terminal which can connect to a radio base station comprising: a storage means which stores position information of predetermined radio base stations corresponding to a user of the mobile terminal; a position measuring means which measures a position of the mobile terminal; a distance calculating means which calculates a distance between a radio base station which is the closest to the position of the mobile terminal, and the mobile terminal among the predetermined radio base stations corresponding to the user; a scan interval determining means which determines an interval which the mobile terminal takes to scan the radio base stations next after scanning the radio base stations, based on the distance; a scanning means which scans the radio base stations; and a scan commanding means which commands the scanning means to perform scan based on the interval.

(Supplementary note 9) A server device which performs communication with a mobile terminal which can connect to a radio base station by way of public mobile wireless communication, the server device comprising: a storage means which stores position information of predetermined radio base stations corresponding to a user of the mobile terminal; a distance calculating means which calculates a distance between a radio base station which is the closest to the position of the mobile terminal and the mobile terminal, among the predetermined radio base stations corresponding to the user; and a scan interval determining means which determines an interval which the mobile terminal takes to scan the radio base stations next after scanning the radio base stations, based on the distance.

(Supplementary note 10) A mobile terminal program which is implemented on a mobile computer which can connect to a radio base station and which comprises a storage means which stores position information of predetermined radio base stations corresponding to a user of the computer, the mobile terminal program causing the computer to execute: position measurement processing of measuring a position of the computer; distance calculation processing of calculating a distance between a radio base station which is the closest to the position of the computer, and the computer among the predetermined radio base stations corresponding to the user; scan interval determination processing of determining an interval which the computer takes to scan the radio base stations next after scanning the radio base stations, based on the distance; and scan processing of scanning the radio base stations based on the interval.

(Supplementary note 11) A server device program which is implemented in a computer which performs communication with a mobile terminal which can connect to a radio base station by way of public mobile wireless communication, and which comprises a storage means which stores position information of predetermined radio base stations corresponding to a user of the mobile terminal, the server device program causing the computer to execute: distance calculation processing of calculating a distance between a radio base station which is the closest to the position of the mobile terminal and the mobile terminal, among the predetermined radio base stations corresponding to the user; and scan interval determination processing of determining an interval which the mobile terminal takes to scan the radio base stations next after scanning the radio base stations, based on the distance.

This application claims priority to Japanese Patent Application No. 2012-213865 filed on Sep. 27, 2012, the entire contents of which are incorporated by reference herein.

Although the present invention has been described above with reference to the exemplary embodiments, the present invention is by no means limited to the above exemplary embodiments. The configurations and the details of the present invention can be variously changed within a scope of the present invention which one of ordinary skilled in art can understand.

### INDUSTRIAL APPLICABILITY

The present invention is suitably applied to control a mobile terminal which scans radio base stations.

### REFERENCE SIGNS LIST

100 Wireless LAN terminal
110 Position information acquiring means
130 Policy analyzing means
140 Wireless LAN scanning means
150 Wireless LAN AP connecting means
200 Analyzing server
220 Distance determining means
240 User information database
250 Policy generating means

What is claimed is:

1-11. (canceled)

12. A scan control system comprising:
a mobile terminal which can connect to a radio base station and which comprises a position measuring unit which measures a position of the mobile terminal;
a storage unit which stores position information of radio base stations;
a distance calculating unit which calculates a distance between a radio base station which is the closest to the position of the mobile terminal and the mobile terminal; and
a scan interval determining unit which determines an interval which the mobile terminal takes to scan the radio base stations next after scanning the radio base stations, based on the distance, wherein the mobile terminal comprises:
a scanning unit which scans the radio base stations; and
a scan commanding unit which commands the scanning unit to perform scan based on the interval.

13. The scan control system according to claim 12, wherein:
the storage unit stores position information of predetermined radio base stations corresponding to a user of the mobile terminal; and
the distance calculating unit calculates the distance between the radio base station which is the closest to the position of the mobile terminal, and the mobile terminal among the predetermined radio base stations corresponding to the user.

14. The scan control system according to claim 12, wherein the storage unit, the distance calculating unit and the scan interval determining unit are provided in a server device which performs communication with the mobile terminal by way of public mobile wireless communication.

15. The scan control system according to claim 12, wherein the storage unit, the distance calculating unit and the scan interval determining unit are provided in the mobile terminal.

16. The scan control system according to claim 12, wherein the mobile terminal comprises a terminal status information acquiring unit which acquires terminal status information which indicates a status of the mobile terminal, and the scan commanding unit determines whether or not scan can be executed based on the terminal status information.

17. The scan control system according to claim 12, wherein the mobile terminal comprises a position information measuring method determining unit which determines a method and an interval with which the position measuring unit measures the position of the mobile terminal, based on the distance calculated by the distance calculating unit; and the position measuring unit measures the position of the mobile terminal according to the method and the interval determined by the position information measuring method determining unit.

18. A scan control method comprising:
at a storage unit, storing position information of predetermined radio base stations corresponding to a user of a mobile terminal which can connect to a radio base station;
at the mobile terminal, measuring a position of the mobile terminal;
at a distance calculating unit, calculating a distance between a radio base station which is the closest to the position of the mobile terminal and the mobile terminal, among the predetermined radio base stations corresponding to the user;
at a scan interval determining unit, determining an interval which the mobile terminal takes to scan the radio base stations next after scanning the radio base stations, based on the distance; and
at the mobile terminal, scanning the radio base stations based on the interval.

19. A mobile terminal which can connect to a radio base station comprising:
a storage unit which stores position information of predetermined radio base stations corresponding to a user of the mobile terminal;
a position measuring unit which measures a position of the mobile terminal;
a distance calculating unit which calculates a distance between a radio base station which is the closest to the position of the mobile terminal, and the mobile terminal among the predetermined radio base stations corresponding to the user;
a scan interval determining unit which determines an interval which the mobile terminal takes to scan the radio base stations next after scanning the radio base stations, based on the distance;
a scanning unit which scans the radio base stations; and
a scan commanding unit which commands the scanning unit to perform scan based on the interval.

20. A server device which performs communication with a mobile terminal which can connect to a radio base station by way of public mobile wireless communication, the server device comprising:
a storage unit which stores position information of predetermined radio base stations corresponding to a user of the mobile terminal;
a distance calculating unit which calculates a distance between a radio base station which is the closest to the position of the mobile terminal and the mobile terminal, among the predetermined radio base stations corresponding to the user; and
a scan interval determining unit which determines an interval which the mobile terminal takes to scan the radio base stations next after scanning the radio base stations, based on the distance.

21. A non-transitory computer-readable recording medium in which a mobile terminal program is recorded, the mobile terminal program is implemented on a mobile computer which can connect to a radio base station and which comprises a storage unit which stores position information of predetermined radio base stations corresponding to a user of the computer, the mobile terminal program causing the computer to execute:
position measurement processing of measuring a position of the computer;
distance calculation processing of calculating a distance between a radio base station which is the closest to the position of the computer, and the computer among the predetermined radio base stations corresponding to the user;
scan interval determination processing of determining an interval which the computer takes to scan the radio base stations next after scanning the radio base stations, based on the distance; and
scan processing of scanning the radio base stations based on the interval.

22. A non-transitory computer-readable recording medium in which a server device program is recorded, the server device program is implemented in a computer which performs communication with a mobile terminal which can connect to a radio base station by way of public mobile wireless communication, and which comprises a storage unit which stores position information of predetermined radio base stations corresponding to a user of the mobile terminal, the server device program causing the computer to execute:
distance calculation processing of calculating a distance between a radio base station which is the closest to the position of the mobile terminal and the mobile terminal, among the predetermined radio base stations corresponding to the user; and
scan interval determination processing of determining an interval which the mobile terminal takes to scan the radio base stations next after scanning the radio base stations, based on the distance.
